(19) United States
(12) Patent Application Publication
(10) Pub. No.: US 2022/0325376 A1
(43) Pub. Date: Oct. 13, 2022

(54) DESULFURISATION OF LEAD-CONTAINING WASTE

(71) Applicants: Stephen Charles ANDREW, Coalville, Leicestershire (GB); Athan FOX, Cambridge (GB); Ramachandran Vasant KUMAR, Cambridge (GB); Spencer David LOWE, Hartlepool (GB); Vimalnath SELVARAJ, Cambridge (GB); Marcel YIAO, Cambridge (GB); EVER RESOURCE LTD, Cambridge (GB); CAMBRIDGE ENTERPRISE LIMITED, Cambridge (GB)

(72) Inventors: Vimalnath SELVARAJ, Cambridge (GB); Stephen Charles ANDREW, Coalville (GB); Athan FOX, Cambridge (GB); Ramachandran Vasant KUMAR, Cambridge (GB); Spencer David LOWE, Hartlepool (GB); Marcel YIAO, Cambridge (GB)

(21) Appl. No.: 17/634,535

(22) PCT Filed: Aug. 12, 2020
(86) PCT No.: PCT/GB2020/051922

§ 371 Date: Feb. 10, 2022

(30) Foreign Application Priority Data
Aug. 12, 2019 (GB) 1911532.8

(51) Int. Cl. C22B 3/00; C22B 7/02; C22B 7/00; C22B 1/00; H01M 10/54; C01G 21/06

(52) U.S. Cl. CPC C22B 13/045; C22B 7/02; C22B 7/006; C22B 1/005; H01M 10/54; C01G 21/06

(57) ABSTRACT

The present invention relates to the desulfurisation of lead-containing waste. In particular, the present invention relates to a method in which lead-containing waste is desulfurised to form a desulfurised lead-containing waste material which is suitable for recycling into lead or leady oxide. The method is particularly suitable for desulfurising lead-acid battery paste.

### FIELD OF THE INVENTION

The present invention relates to the desulfurisation of lead-containing waste. In particular, the present invention relates to a method in which lead-containing waste is desulfurised to form a desulfurised lead-containing waste material which is suitable for recycling into lead or leady oxide. The method is particularly suitable for desulfurising lead-acid battery paste.

### BACKGROUND TO THE INVENTION

Lead-acid batteries are widely used in the automotive and other industries due to their rechargeable nature and relatively low cost.

During discharge, the lead and lead dioxide that is present in the battery plates converts to lead sulfate. Recharging the battery converts the lead sulfate back to lead and lead dioxide. Although lead-acid batteries are rechargeable, over time lead sulfate can crystallise as large passivating crystals in the battery plates thereby reducing the propensity of lead sulfate to convert back into lead and lead dioxide. This results in a deterioration of battery performance. Eventually, the battery will have to be replaced.

In Europe and the USA, a high proportion of waste lead-acid batteries are recycled. In a typical process, the used batteries are crushed and the lead-containing solids separated from other battery waste components such as plastic materials and the electrolyte. The lead-containing solids originate from the battery plate which is made up of a battery grid and a battery paste. The spent battery paste is passed to a smelter for pyrometallurgical processing into a lead ingot. The lead ingot may then be used for manufacturing new lead-acid batteries. For instance, lead ingot may be used to manufacture a new battery grid, or it may be oxidised using a Barton pot or ball-mill process to produce leady oxide, typically a mixture of lead oxide and free metallic lead. This leady oxide may then be reused as the active, redox material in lead-acid battery plates.

These traditional recycling processes are highly energy intensive, with temperatures of approximately 1,100° C. required for the decomposition of lead sulfate. Traditional recycling processes can also be highly polluting. For instance, sulfur dioxide may be produced in the high-temperature smelter. In order to prevent pollutants from being released into the atmosphere, specialist equipment and time-consuming processes are required. These can represent a significant expense in the recycling process.

Thus, many lead-acid battery recycling processes now include a step in which the spent battery paste is desulfurised before it is, either directly or indirectly, passed to a smelter. Typically, spent battery paste is desulfurised by combining the paste with aqueous sodium carbonate in a leaching tank, and subjecting the mixture to mechanical agitation. The lead component is converted into lead carbonate, while the sulfate component dissolves in the aqueous system in the form of sodium sulfate which can then be separated from the desulfurised paste by filtration (see Lyakov et al., J. Power Sources 2007, 171, 960-965). However, it is difficult to achieve high levels of desulfurisation using these processes, with desulfurisation levels in the range of from 92 to 94% typically obtained.

Though sodium hydroxide has successfully been used to desulfurise spent battery paste in greater amounts—typically in the range of from 94 to 97% (see Lyakov supra)—this is still below the level of desulfurisation that would ideally be obtained in an industrial process in order to dispense with the requirement for sulfur dioxide removal during smelting. Moreover, the methods require the use of an excess of sodium hydroxide which enhances the reagent load of the process.

The limit on the desulfurisation levels achieved using sodium hydroxide in the prior art is believed to be due to the formation of lead hydroxides. These are hydrated forms of lead oxide and principally take the form Pb(OH)₂ (or PbO.H₂O), though other forms may also be present such as Pb₅O₃(OH)₄, and Pb₃O₂(OH)₂ (or 3PbO.H₂O). However, lead hydroxides have a tendency to precipitate from aqueous solutions to form a colloidal mixture. The particles in the colloidal mixture can be large enough to cause difficulties during stirring and filtration, thereby reducing the industrial viability of existing hydroxide desulfurisation processes. The formation of soluble by-products in prior art processes, such as sodium plumbite, can also reduce the proportion of the lead-containing waste that is recycled. Loss of lead burden is particularly acute in prior art processes where the aqueous phase is used in relatively large amounts.

There is therefore a need for a method of desulfurising lead-containing waste, particularly waste originating from lead-acid batteries, which addresses one or more of the problems identified above.

### SUMMARY OF THE INVENTION

The present invention is based on the surprising discovery that, by maintaining a pH in the range of from 11 to 15 during desulfurisation of lead-containing waste, highly selective formation of lead (II) oxide over other lead compounds may be achieved. In particular, in prior art methods where the pH is not controlled during the desulfurisation reaction, the pH level rapidly drops as the hydroxide reagent is used up, and this is believed to promote the formation of lead hydroxide. By controlling the pH throughout a desulfurisation step, and thereby avoiding the formation of unwanted by-products, close to stoichiometric conversion of lead sulfate to lead (II) oxide may be achieved, even where the sulfate content of the feedstocks is unknown. Thus, the reaction may be both highly selective for lead (II) oxide and approaching stoichiometric. This makes the process highly efficient.

Accordingly, in a first aspect, the present invention provides a method for desulfurising lead-containing waste, the lead containing waste comprising PbSO₄, said method comprising:
(a) treating an aqueous slurry of the lead-containing waste with a hydroxide base thereby forming desulfurised lead-containing waste in which PbSO₄ has been converted to PbO and an aqueous solution comprising sulfate anions; and
(b) separating the desulfurised lead-containing waste from the aqueous solution comprising sulfate anions,

wherein a pH in the range of from 11 to 15 is maintained during step (a).

The present invention further provides a desulfurised lead-containing waste which is obtainable using a method as defined herein, as well as a desulfurised lead-containing waste, which is preferably a desulfurised lead-acid battery paste, which comprises:
PbO in an amount of at least 40%;
PbO₂ in an amount of at least 10%;
Pb in an amount of at least 1%; and
lead hydroxide forms in an amount of less than 5%;
by weight.

Also provided is a method of recycling lead-containing waste, said method comprising processing a desulfurised lead-containing waste into a lead-containing material, wherein the desulfurised lead-containing waste is as defined herein. The method preferably comprises providing the desulfurised lead-containing waste using a method as defined herein.

### DESCRIPTION OF VARIOUS EMBODIMENTS

Lead-Containing Waste

The present invention provides a method for desulfurising lead-containing waste. The lead-containing waste comprises lead sulfate (referred to herein as PbSO₄). The lead-containing waste may comprise PbSO₄ in an amount of at least 1%, preferably at least 10%, and more preferably at least 20% by weight.

The lead-containing waste used in step (a) may also comprise lead in a number of forms other than PbSO₄. For instance, the lead-containing waste may contain metallic lead (referred to herein as Pb) or lead in the form of a compound, such as lead oxide (referred to herein as PbO for lead (II) oxide and PbO₂ for lead (IV) oxide) or lead carbonate (referred to herein as PbCO₃). It will be appreciated that these materials may be present in the form of compounds of the materials, e.g. PbO.PbSO₄, 3PbO.PbSO₄ or 4PbO.PbSO₄, and hydrates thereof, though these forms will typically be present in only negligible amounts, if at all.

Preferably, the lead-containing waste used in step (a) contains at least one of Pb and PbO. More preferably, the lead-containing waste used in step (a) contains Pb and PbO. The lead-containing waste used in step (a) may further contain PbO₂. The amount of different lead-containing materials in the lead-containing waste will, of course, vary depending on the source of the lead-containing waste.

Non-lead components may also be present in the lead-containing waste, e.g. in an amount of at least 0.1% by weight, though these are typically present in an amount of less than 10%, preferably less than 5%, such as less than 3% or less than 1% by weight. Non-lead components may include metal compounds, insoluble carbon materials and fibres. Metal compounds include barium sulfate, an additive which is often included in lead-acid battery plates to minimise or control crystallisation of lead sulfate. Insoluble carbon materials are typically added as expanders for lead-acid battery plates, and may comprise carbon black, graphene or carbon nanotubes. Fibres which are often included in lead-acid battery plates include lignosulfonates. Non-lead component may also include polymers or glass, e.g. from separators that may be used in a lead-acid battery.

The method of the present invention is particularly suitable for desulfurising lead-acid battery paste. Thus, in embodiments, the lead-containing waste that is used in step (a) is derived from lead-acid battery paste. Lead-acid battery paste typically comprises PbSO₄, PbO, PbO₂ and Pb. The proportion of these components in lead-acid battery paste from single batteries may vary significantly depending on the degree to which the battery has been ‘spent’, i.e. used. For instance, lead-acid battery paste from a little-used battery, may find itself in ‘waste’, but will typically contain relatively large amounts of Pb and PbO₂, and relatively small amounts of PbSO₄ and PbO. Moreover, where the lead-acid battery paste is taken from just the negative plate, it may not contain any PbO₂.

However, waste from lead-acid batteries is typically made up of paste from a large number of batteries and so its content of different lead-containing materials is somewhat normalised. Thus, the waste lead-acid battery paste used in step (a) may contain PbSO₄ in an amount of at least 40% by weight. The waste lead-acid battery paste used in step (a) may contain PbO in an amount of at least 5% by weight. The waste lead-acid battery paste used in step (a) may contain PbO₂ in an amount of at least 10% by weight. The waste lead-acid battery paste used in step (a) may contain Pb in an amount of at least 1% by weight.

Lead-acid battery paste may be obtained from lead-acid batteries by known methods. For instance, lead-acid battery paste may be obtained by a method in which one or more lead-acid batteries are crushed and the lead-containing waste separated from the other components of the batteries such as plastic materials and the electrolyte. Thus, in some embodiments, the present invention involves a pre-treatment step in which used batteries are crushed, and the lead-containing solids separated from other battery waste components such as plastic materials and the electrolyte before being used in step (a).

Lead-containing waste is also available from a number of other sources. The lead-containing waste may be from a mineral, metallurgical or chemical plant. The lead-containing waste may be a product of PbS ore mining, which has been oxidised by roasting to contain PbSO₄ with impurities such as silica.

In some instances, the method of the present invention is used for desulfurising electric arc furnace dusts. Electric arc furnace dust is a residue from the production of steel. The presence of zinc in the dust and rising disposal costs have led to initiatives for recycling the dust. This is most commonly done using the Waelz process in which zinc-containing material is treated in a rotary kiln. The process is usually carried out in the presence of carbon (e.g. in the form of coke) and preferably also calcium oxide (CaO) or silicon dioxide (SiO₂). The kiln will typically be operated at a temperature of from 1000 to 1500° C.

However, electric arc furnace dusts may contain a number of impurities, including lead sulfate. Thus, in embodiments, the lead-containing waste that is used in step (a) is derived from electric arc furnace dusts.

The lead-containing waste used in step (a) may be the electric arc furnace dusts obtained directly from the production of steel. In other words, the electric arc furnace dusts have not yet been subjected to further processing steps, such as zinc recycling processes.

However, in preferred embodiments, the lead-containing waste used in step (a) is the material left behind after zinc has been removed from the electric arc furnace dusts, e.g. in the Waelz process. This material is known as slag (or Waelz clinker) and may contain PbSO₄ in an amount of at least 40% by weight. Thus, the lead-containing waste used in step (a) may preferably be slag from a Waelz process which contains PbSO₄ in an amount of at least 10%, preferably at least 20%, and more preferably at least 40% by weight.

Where the lead-containing material that is used in step (a) is slag from a Waelz process, the slag has preferably been pre-processed with heat. This is believed to remove carbonaceous materials that are used in the Waelz process and which may be present in the Waelz slag, e.g. in an amount of at least 10% by weight. In some embodiments, the method of the present invention comprises the step of pre-processing the Waelz slag with heat, though in other embodiments the slag has already been pre-processed.

Pre-processing of the slag may be carried out at a temperature of at least 500° C., preferably at least 550° C. and more preferably at least 600° C. Pre-processing of the slag may be carried out at a temperature of up to 800° C., preferably up to 750° C. and more preferably up to 700° C. Pre-processing of the slag may be carried out at a temperature of from 500 to 800° C., preferably from 550 to 750° C. and more preferably from 600 to 700° C.

Pre-processing of the slag may be carried out for a period of at least 15 minutes, preferably at least 30 minutes, and more preferably at least 45 minutes. Pre-processing of the slag may be carried out for a period of up to 4 hours, preferably up to 2 hours, and more preferably up to 90 minutes. Thus, pre-processing of the slag may be carried out for a period of from 15 minutes to 4 hours, preferably from 30 minutes to 2 hours, and more preferably from 45 to 90 minutes.

Lead-containing waste may be found in many forms, e.g. in the form of a dust, slag or sludge, or even in the form of a mineral. However, the lead-containing waste used in step (a) will typically be in a crushed form, e.g. as rubble or granules. For instance, the lead-containing waste used in step (a) may be in a particulate form, where at least 100% by weight (i.e. d100) of the granules pass through a mesh having openings with a diameter of 1 cm, preferably 5 mm, and more preferably 2 mm. The lead-containing waste will typically be used in step (a) is a fairly crude mixture of sizes which have been prepared by crushing lead-containing waste materials.

As is explained in greater detail below, the particle size of the lead-containing waste may be further reduced in step (a) by communition.

It will be appreciated that the lead-containing waste that is used in step (a) is in the form of a solid. Nevertheless, due to the process by which it is obtained, it may be coated in liquid, e.g. in battery acid, though any such liquids are not considered to form part of the lead-containing wastes.

Step (a)—Treating in the Presence of a Base

In step (a) of the method of the present invention, an aqueous slurry of the lead-containing waste is treated with a hydroxide base. This results in the formation of desulfurised lead-containing waste in which PbSO₄ has been converted to PbO and an aqueous solution into which sulfate ions have been extracted.

Step (a) is carried out at a pH in the range of from 11 to 15. It has been discovered that, by maintaining a pH value within this range, PbSO₄ may be selectively converted into PbO, which is the preferred form of lead for downstream processing of the desulfurised lead-containing waste. In particular, it has been found that, if the pH drops below 11, then significant amounts of lead hydroxide forms and unconverted PbSO₄ may be observed in the desulfurised paste. Above a pH of 15, significant levels of plumbite salts (i.e. salts containing the PbO₂²⁻ ion) may form, e.g. with the cation of the hydroxide base; these salts are highly soluble in aqueous systems thereby leading to lead loss.

A pH may be maintained in step (a) of at least 11.5, preferably at least 12, and more preferably at least 12.5. A pH may be maintained in step (a) of up to 14.5, preferably u p to 14.25, and more preferably up to 14. Thus, a pH may be maintained in step (a) in the range of from 11.5 to 14.5, preferably from 12 to 14.25, and more preferably from 12.5 to 14. In particularly preferred instances, a pH may be maintained in step (a) of greater than 13. For instance, a pH may be maintained in the range of from 13 to 14, for instance by setting a target pH of 13.5 and allowing fluctuations in pH of ±0.5.

pH is measured under the conditions that are used in step (a) using conventional methods e.g. a pH probe. It will be appreciated that, where step (a) is carried out in a mill (or other comminuting device)—as is described in greater detail below—a pH probe will generally not be inserted into the grinding section of the mill but will rather be placed a location in which the measured pH will be substantially the same as that in the grinding section, e.g. in a chamber which is in fluid communication with the slurry or, where a classifier is used, preferably in the classifier (e.g. a classifier bath). By placing the pH probe away from the grinding section, mechanical wear on the probe may be reduced.

The pH is preferably maintained by monitoring the pH during step (a), and adding further of the hydroxide base to the slurry where necessary. This ensures that, at the end of desulfurisation step (a), the pH of the aqueous slurry is within the target range. The amount of base that is required to maintain a particular pH level will, of course, vary based on the different sources of lead-containing waste, and the progress of the reaction, and can be readily determined by a person of skill in the art.

Various hydroxide bases may be used in step (a) of the present invention. Preferably, the base is selected from metal hydroxides, such as from alkali metal hydroxides (e.g. NaOH, KOH or LiOH) and alkaline earth metal hydroxides. Particularly preferred is the use of alkali metal hydroxides, such as NaOH, as the base.

As mentioned above, by controlling the pH, and thereby avoiding the formation of unwanted by-products, close to stoichiometric conversion may be achieved. The stoichiometry of the reaction with an alkali metal hydroxide (MOH, where M is e.g. Na or another alkali metal) is shown in the following equation:

PbSO₄+2MOH→M₂SO₄+PbO+H₂O

Thus, the base may be consumed in step (a) in an amount of at least 1.9 moles, preferably at least 1.95 moles, and more preferably at least 1.98 moles per mole of lead sulfate in the lead-containing waste. The base may be consumed in step (a) in an amount of up to 2.1 moles, preferably up to 2.05 moles, and more preferably up to 2.02 moles per mole of lead sulfate in the lead-containing waste. Thus, the base may be consumed in step (a) in an amount of from 1.9 to 2.1 moles, preferably from 1.95 to 2.05 moles, and more preferably from 1.98 to 2.02 moles per mole of lead sulfate in the lead-containing waste. It will be appreciated that where an alkaline earth metal hydroxide is used, the stoichiometry of the reaction changes and, as such, the consumption of the base in step (a) is preferably half of those mentioned above. Any hydroxide base that is present but not used up during the reaction may be recycled for further use.

The aqueous slurry in step (a) has a solids content of at least 30%, preferably at least 50%, and more preferably at least 55% by weight. The aqueous slurry may have a solids content of up to 80%, preferably up to 70%, and more preferably up to 65% by weight. Thus, the aqueous slurry may have a solids content of from 30 to 80%, preferably from 50 to 70%, and more preferably from 55 to 65% by weight. Prior art processes typically use a low solids content, and it is surprising that the low-aqueous systems used in the present invention are so effective.

As will be discussed in further detail below, the desulfurisation method of the present invention may involve a conditioning step in which water is added to the desulfurised lead-containing waste and the aqueous solution comprising sulfate ions that is formed in step (a). Where this step is not present, i.e. the products of step (a) directly separated in step (b), then the aqueous slurry of lead-containing waste preferably has a solids content of up to 35%, e.g. from 25 to 35% by weight, to ensure that the sulfate ions (e.g. in the form of a metal salt, for instance Na₂SO₄ if NaOH is the base) that are produced during step (a) remain in solution.

Step (a) may be carried out at a temperature of at least 0° C., preferably at least 10° C., and more preferably at least 20° C. Step (a) may be carried out at a temperature of up to 70° C., preferably up to 65° C., and more preferably up to 60° C. Thus, step (a) may be carried out at a temperature of from 0 to 70° C., preferably from 10 to 65° C., and more preferably from 20 to 60° C. Typically, neither heating nor cooling is applied during step (a). However, it is preferred that the temperature is maintained at or less than 60° C. to avoid any unwanted dissolution of lead compounds. Since heat is typically generated during the desulfurisation reaction, in some embodiments, e.g. where the lead-containing waste has a high concentration of PbSO₄, cooling may be applied during step (a) so that the temperature does not exceed 60° C.

Step (a) will typically be carried out at ambient pressure, i.e. without the application or removal of pressure.

Step (a) may be carried out for a period of at least 10 minutes, preferably at least 20 minutes, and more preferably at least 30 minutes. Step (a) will typically be carried out for a period of up to 3 hours, preferably up to 2 hours, and more preferably up to 90 minutes. Thus, step (a) may be carried out for a period of from 10 minutes to 3 hours, preferably from 20 minutes to 2 hours, and more preferably form 30 minutes to 90 minutes. It will be appreciated that, in a continuous desulfurisation process, these values represent the median average residence time in the system.

In preferred embodiments, the lead-containing waste is comminuted during step (a). It will be appreciated that the particle size of the lead-containing waste is reduced during comminution. Preferably, when comminuted, the desulfurised lead-containing waste that is produced in step (a) is in a particulate form, where at least 80% by weight (i.e. d80) of the particles pass through a mesh having openings with a diameter of 150 μm, preferably 75 μm, and more preferably 63 μm. Preferably, when comminuted, the desulfurised lead-containing waste produced in step (a) is in a particulate form, where 100% by weight (i.e. d100) of the particles pass through a mesh having openings with a diameter of 250 μm, preferably 125 μm, and more preferably 75 μm. Particles of this size may provide excellent levels of desulfurisation.

A variety of methods may be used for comminuting the lead-containing waste, e.g. crushing, grinding, or vibrating. Preferably, the lead-containing waste is comminuted by grinding. The grinding may be carried out in a mill. A grinding medium, such as balls or rods, is preferably used in the mill, to improve the grinding process. Thus, in preferred embodiments, step (a) will be carried out in a ball mill or a rod mill, and preferably a ball mill.

The preferred operating speed of the mill will be dependent on several factors, including its size. Preferably, the ball mill is operated at a speed below 90% of the critical speed, and more preferably between 60 to 85% of the critical speed of the mill, i.e. the speed at which the mill becomes a centrifuge. Since critical speed is related to the diameter of the mill cylinder, the preferred operating speed will be dependent on the scale on which the desulfurisation is performed. The mill may typically be operated at a speed of at least 5 rpm, preferably at least 10 rpm, and more preferably at least 15 rpm. The mill may be operated at a speed of up to 60 rpm, preferably up to 40 rpm, and more preferably up to 30 rpm. Thus, the mill may be operated at a speed of from 5 to 60 rpm, preferably from 10 to 40 rpm, and more preferably from 15 to 30 rpm.

The mill may be operated in batch mode, though preferably it is operated in a continuous mode, i.e. with lead-containing waste being fed into the mill and desulfurised lead-containing waste removed from the mill continuously. This use of continuous milling reduces fluctuations in pH as the—often acidic—feed is added, since there is a reservoir of material already at the correct pH in the mill. Furthermore, any temperature rises that may occur as a result of milling and desulfurisation may be levelled out.

In particularly preferred embodiments, the mill is operated as a closed circuit mill. This term is understood to denote a system in which the ground material is discharged to a classifier, with the classifier returning any oversize material to the mill for further grinding. These embodiments are particularly preferred, since they allow for the continuous processing of different feedstocks having a varied, and unknown, sulfate content by simply maintaining the pH level of the system.

Conditioning Step

The mixture of lead-containing waste and aqueous solution comprising sulfate ions that is formed in step (a) may also be used directly in step (b). However, the method of the present invention will generally comprise a conditioning step between steps (a) and (b). The conditioning step is typically carried out in one or more conditioning tanks, though it could also be carried out in the vessel, e.g. the mill, in which step (a) is carried out.

A conditioning step may be used for two purposes: to ensure that any sulfate ions are in solution; and/or to ensure that desulfurisation is complete.

To ensure that any sulfate ions are in solution, the conditioning step may comprise a dilution step in which water is added to the desulfurised lead-containing waste and the aqueous solution comprising sulfate ions that is formed in step (a). This also has the advantage of lowering the pH of the system. The products of step (a) are typically subjected to mixing during the dilution step.

Water may be added in an amount which gives a slurry having a solids content of up to 40%, preferably up to 35%, and more preferably up to 30% by weight. Water may be added in an amount which gives a slurry having a solids content of at least 15%, preferably at least 20%, and more preferably at least 25% by weight. Thus, water may be added in an amount which gives a slurry having a solids content of from 15 to 40%, preferably from 20 to 35%, and more preferably from 25 to 30% by weight.

To ensure that desulfurisation is complete—e.g. if a particle is small enough to pass through a classified in a closed circuit mill, but is the result of a fresh break of a large particle with high PbSO₄ content—the conditioning step may comprise leaving the desulfurised lead-containing waste and the aqueous solution comprising sulfate ions that are formed in step (a) in a tank for a period of time. It will be appreciated that, where a closed circuit mill is used, base will be removed from the slurry with the classified particles thereby enabling desulfurisation to continue in a tank to which the classified particles have been passed. The tank is preferably the conditioning tank in which the dilution step is carried out, though it could also be the vessel in which step (a) is carried out, or another conditioning tank. In these embodiments, where a dilution step is also carried out, it will be appreciated that dilution occurs after the products of step (a) have been left in a tank for a period of time.

The products of step (a) may be left in a tank for a period of at least 1 minute, preferably at least 2 minutes, and more preferably at least 5 minutes. The period may be up to 30 minutes, preferably up to 20 minutes, and more preferably up to 15 minutes. Thus, the period may be from 1 to 30 minutes, preferably from 2 to 20 minutes, and more preferably from 5 to 15 minutes.

Generally, it will not be necessary to leave the products of step (a) in a tank for a period of time, particularly where the desulfurised lead-containing waste that is produced in step (a) is in the form of particles which pass through a mesh having openings of 100 μm or less.

Step (b)—Isolating the Desulfurised Lead-Containing Waste

The desulfurised lead-containing waste may be separated from the aqueous solution comprising sulfate ions using filtration, though a variety of other methods may be used such as a settling tank or centrifugation.

Preferably, the desulfurised lead-containing waste is separated from the aqueous solution comprising sulfate ions using pressure filtration. A pressure may be applied during filtration of at least 2 bar, preferably at least 4 bar, and more preferably at least 5 bar. A pressure may be applied of up to 50 bar, preferably up to 20 bar, and more preferably up to 10 bar. Thus, a pressure may be applied of from 2 to 50 bar, preferably from 4 to 20 bar, and more preferably from 5 to 10 bar.

The slurry of desulfurised lead-containing waste and aqueous solution comprising sulfate ions is preferably filtered using a filter press through a press cloth, e.g. having a pore size of up to 50 μm, preferably up to 30 μm, and more preferably up to 20 μm. Other filtration methods include belt filter presses.

Step (b) may comprise washing the separated desulfurised lead-containing waste—whether isolated by filtration or otherwise—with water, to ensure that all sulfate ions have been removed. In some embodiments, the method comprises monitoring the sulfate content of the used wash water to determine when a target level of sulfate has been achieved. Monitoring may be done by direct measurement of sulfate content, but it is preferably done indirectly e.g. by measuring the conductivity of the wash water. The target conductivity of the used wash water is up to 4000 μS/cm, preferably up to 2000 μS/cm, and more preferably up to 1000 μS/cm, greater than the conductivity of the wash water before it is contacted with the separated desulfurised lead-containing waste. The conductivity of the wash water may be monitored using convention methods, e.g. using a conductivity meter.

In some embodiments, the method may further comprise isolating the sulfate ions, e.g. by crystallising as a result of evaporating the water, from the filtrate (i.e. the aqueous solution comprising sulfate ions) and optionally using the sulfate ions in another application. For instance, the recovered sulfate may be used in the production of glass. The wash water may be combined with the filtrate for this, or other, further processing. However, the filtrate and wash water streams are typically kept separate so as to maintain a high concentration of sulfate ions in the filtrate.

The process of the present invention may be used to remove a very high proportion of sulfates from the lead-containing waste. Preferably, at least 95%, preferably at least 98%, and more preferably at least 99%, of the sulfur burden is removed from the lead-containing waste. The reduction in sulfur may be measured using known methods, e.g. spectroscopic techniques such as ICP-AES (inductively coupled plasma atomic emission spectroscopy). ICP-AES may be carried out as detailed in the examples.

The method may therefore be used to produce, at the end of step (b), desulfurised lead-containing waste which contains a very low amount of lead sulfate. The desulfurised lead-containing waste obtained at the end of step (b) preferably contains less than 1%, preferably less than 0.1%, and more preferably less than 0.01% by weight of PbSO₄.

The desulfurised lead-containing waste obtained at the end of step (b) preferably contains less than 1%, more preferably less than 0.5%, and most preferably less than 0.1% by weight of lead hydroxide forms. Particularly preferred embodiments of the invention may result in production of desulfurised lead-containing waste comprising substantially no forms of lead hydroxide. It will be appreciated that lead hydroxide forms may include Pb(OH)₂ and other hydroxide forms such as Pb₅O₃(OH)₄ and Pb₃O₂(OH)₂.

The desulfurised lead-containing waste obtained at the end of step (b) preferably contains less than 2%, preferably less than 1%, and more preferably less than 0.5% by weight of PbCO₃. Typically, the desulfurised lead-containing waste obtained at the end of step (b) will be free from PbCO₃.

The amount of PbSO₄, lead hydroxide forms and PbCO₃ may be determined using known methods, e.g. XRD (X-ray diffraction). XRD may be carried out as detailed in the examples.

The desulfurised lead-containing waste obtained at the end of step (b) may contain at least 95%, preferably at least 99%, and more preferably at least 99.9% of the lead burden that was present in the lead-containing waste used in step (a). Lead burden may be measured using known methods, e.g. spectroscopic techniques such as ICP-AES (inductively coupled plasma atomic emission spectroscopy). In particular, the lead-containing waste may be dissolved in nitric acid (8 parts) and hydrogen peroxide (2 parts) at around 80° C., with stirring, for 30 minutes. The amount of lead in solution may then be measured using ICP-AES. ICP-AES may be carried out as detailed in the examples.

The desulfurised lead-containing waste obtained at the end of step (b) may contain at least 40%, preferably at least 50%, and more preferably at least 60% by weight of PbO. The proportion of PbO by weight present in the desulfurised lead-containing waste may be measured using known methods, e.g. spectroscopic techniques such as ICP-AES. In particular, the lead-containing waste may be dissolved in 5% aqueous acetic acid at room temperature, with stirring, for 1 minute. The amount of lead in solution may then be measured using ICP-AES. ICP-AES may be carried out as detailed in the examples.

The present invention provides a desulfurised lead-containing waste which is obtainable using a method of the present invention. The present invention further provides a desulfurised lead-containing waste, preferably a desulfurised lead-acid battery paste, which may be obtained using a method of the present invention, which comprises by weight:
PbO in an amount of at least 40%;
PbO₂ in an amount of at least 10%;
Pb in an amount of at least 1%; and
lead hydroxide forms in an amount of less than 5%.

Further Processing of the Desulfurised Waste

The desulfurised lead-containing waste that is described herein may be further processed in a number of different routes, and preferably into a lead-containing material. Thus, the present invention provides a method of recycling lead-containing waste, said method comprising:
(i) preparing a desulfurised lead-containing waste using a method as defined herein; and
(ii) further processing the desulfurised lead-containing waste into a lead-containing material.

Step (i) may also be omitted and step (ii) carried out using desulfurised lead-containing waste that is obtainable using a method of the present invention.

In a first instance, the desulfurised lead-containing waste may be further processed in a furnace (e.g. a smelter) into a lead ingot. Since the desulfurised lead-containing waste contains very low levels of lead sulfate, the smelter may be operated at relatively low temperatures. For instance, the smelter may be operated at a temperature of from 800 to 1000° C. Furthermore, the low levels of lead hydroxides in the desulfurised lead-containing waste mean that less energy is used converting lead hydroxide forms into lead oxide in the smelter and dealing with the water produced in this conversion. The substantial absence of carbonates (which are present is carbonate desulfurisation methods) also means that CO₂ is not produced in the smelter. The use of iron, soda and silica in the smelter may also be avoided, due to the low levels of PbSO₄ in the desulfurised waste. Thus, in some embodiments, the smelter is operated in the absence of iron, soda and/or silica.

In a second instance, the desulfurised lead-containing waste may be further processed by:

(a) treating waste with aqueous citric acid solution so as to generate lead citrate;

(b) isolating lead citrate from the aqueous solution; and

(c) converting the isolated lead citrate to Pb and/or PbO.

In the second instance, the further processing may be carried out as described in WO 2008/056125.

In a third, preferred, instance, the desulfurised lead-containing waste may be further processed by:
(a) dissolving the lead-containing waste in an aqueous solution of a first acid to form a solution of a first lead salt;
(b) adding a second acid to the solution of the first lead salt to form a lead-depleted solution and a precipitate of a second lead salt; and
(c) converting the precipitate of the second lead salt into leady oxide,

wherein the first lead salt has a higher solubility in water than the second lead salt.

In the first step (a) of the third further processing method, the lead-containing waste is dissolved in an aqueous solution of a first acid resulting in the formation of a solution of a first lead salt.

It will be appreciated that the first lead salt will have a lead cation, with the anion being from the first acid. In preferred embodiments, the first lead salt is a lead(II) salt. The first lead salt preferably has a solubility in water of at least 100 g/L, preferably at least 200 g/L, and more preferably at least 300 g/L. References herein to solubility refer to equilibrium solubility in water at 25° C.

The first acid is preferably a Brønsted-Lowry acid, i.e. a proton donor. The first acid may be an organic acid or an inorganic acid, however preferred first acids are organic acids. A particularly suitable organic acid is acetic acid which forms a solution of lead acetate Pb(CH₃COO)₂. Other organic acids that could be used include carboxylic acids such as maleic acid. Suitable inorganic acids include nitric acid.

The aqueous solution of the first acid preferably has a molarity of at least 0.1 mol/L, preferably at least 0.25 mol/L, and more preferably at least 0.5 mol/L. The aqueous solution of the first acid preferably has a molarity of up to 7 mol/L, preferably up to 3 mol/L, and more preferably up to 1.5 mol/L. Thus, the aqueous acid solution of the first acid may have a molarity of from 0.1 to 7 mol/L, preferably from 0.25 to 3 mol/L, and more preferably from 0.5 to 1.5 mol/L.

The lead-containing waste is preferably added to the aqueous solution of the first acid in an amount of at least 10 g, preferably at least 50 g, and more preferably at least 80 g of waste per litre of aqueous acid. The lead-containing waste may be added to the aqueous solution of the first acid in an amount of up to 650 g, preferably up to 300 g, and more preferably u p to 150 g of waste per litre of aqueous acid. Thus, the lead-containing waste may be added to the aqueous solution of the first acid in an amount of from 10 to 650 g, preferably from 50 to 300 g, and more preferably from 80 to 150 g of waste per litre of aqueous acid.

The lead-containing waste may be dissolved in the aqueous solution of the first acid at a temperature of at least 0° C., preferably at least 10° C., and more preferably at least 15° C. The lead-containing waste may be dissolved in the aqueous solution of the first acid at a temperature of up to 90° C., preferably up to 50° C., and more preferably up to 30° C. Thus, the lead-containing waste may be dissolved in the aqueous solution of the first acid at a temperature of from 0 to 90° C., preferably from 10 to 50° C., and more preferably from 15 to 30° C.

It will be appreciated that higher temperatures and higher concentrations of the first acid will typically be used for dissolution step (a) where higher amounts of lead containing waste are used.

The lead-containing waste will typically be dissolved in the aqueous solution of the first acid at ambient pressure, i.e. without the application or removal of pressure.

The lead-containing waste may be dissolved in the aqueous solution of the first acid for a period of from 1 to 120 minutes, preferably from 5 to 60 minutes, and more preferably from 15 to 45 minutes.

In some embodiments, it may be desirable to contact the lead-containing waste with a redox reagent. This assists dissolution of lead-containing materials that are not in the +2 oxidation state by conversion into the +2 oxidation state. For instance, a redox reagent may convert lead-containing materials in the +4 oxidation state such as PbO₂ into PbO, which then readily reacts with the aqueous solution of the first acid to form a soluble salt. Without the use of a redox reagent, the conversion of PbO₂ into a salt will generally proceed fairly slowly. A redox reagent may also assist with the conversion of metallic lead into PbO, though Pb may also form a salt with the first acid without contact with a redox reagent.

Preferably, the redox reagent will be a reducing agent, for instance for lead compounds in the +4 oxidation state. Preferably, the redox reagent will also be an oxidising agent, for instance for metallic lead. Particularly preferred redox reagents include hydrogen peroxide which functions both as an oxidising agent and reducing agent. However, other redox reagents may be used. For example, metal hydrides, hydrogen gas or inorganic salts may be used as reducing agents. Organic redox agents may also be used.

The redox reagent may be contacted with the lead-containing waste before or during step (a) of the recycling method. When the redox reagent is contacted with the lead-containing waste during step (a), the redox reagent may be introduced into the aqueous solution of the first acid before the lead-containing waste is dissolved therein, or the redox reagent may be introduced once the lead-containing waste has already been partially dissolved.

The redox reagent may be used in the form of a solution having a molarity of at least 1 mol/L, preferably at least 3 mol/L, and more preferably at least 5 mol/L. The redox reagent may be used in the form of a solution having a molarity of up to 25 mol/L, preferably up to 20 mol/L, and more preferably up to 15 mol/L. Thus, the redox reagent may be used in the form of a solution having a molarity of from 1 to 25 mol/L, preferably from 3 to 20 mol/L, and more preferably from 5 to 15 mol/L.

The redox reagent solution may be added to the aqueous solution of the first acid in an amount of at least 1 ml, preferably at least 5 ml, and more preferably at least 10 ml per litre of aqueous acid. The redox reagent solution may be added to the aqueous solution of the first acid in an amount of up to 100 ml, preferably up to 50 ml, and more preferably u p to 30 ml per litre of aqueous acid. Thus, the redox reagent solution may be added to the aqueous solution of the first acid in an amount of from 1 to 100 ml, preferably from 5 to 50 ml, and more preferably from 10 to 30 ml per litre of aqueous acid.

In some embodiments, the lead-containing waste used in step (a) may comprise material which is insoluble in the aqueous solution of the first acid and so remains as an insoluble material in the solution of the first lead salt. Insoluble material may be present in the lead-containing waste in an amount of at least 0.01%, more typically at least 0.1%, and still more typically at least 1% by weight. For instance, lead-acid battery paste typically contains from 2 to 5%, and more typically from 3 to 3.5% by weight of insoluble material.

The insoluble material may comprise one or more of metal compounds such as barium sulfate, carbon such as carbon black, graphene and/or carbon nanotubes, and fibres such as lignosulfonates. In some embodiments, the insoluble material comprises metal compounds, carbon and fibres. The insoluble material may also comprise polymers or glass. The insoluble material may also contain some lead, though this is generally less preferred. For instance, the insoluble material may comprise Pb, e.g. if it is present in relatively large particle sizes or the dissolution period is short.

Where the lead-containing waste comprises insoluble materials, these are preferably recovered from the solution that is formed in step (a). By dissolving the lead-containing waste in an aqueous solution of the first acid, the opportunity to remove insoluble components that would represent impurities in leady oxide, but which are valuable in their isolated form, is provided. In some embodiments, the recovered insoluble materials are reused.

Suitable methods for recovering the insoluble material from the solution of the first lead salt that is formed in step (a) include filtration, though a variety of other methods may be used such as a settling tank or centrifugation.

In the second step (b) of the third further processing method, a second lead salt is precipitated by the addition of a second acid to the solution of the first lead salt. This leads to the formation of a lead-depleted solution and a precipitate of a second lead salt.

It will be appreciated that the second lead salt will have a lead cation, with the anion being from the second acid. In preferred embodiments, the second lead salt is a lead(II) salt. The second lead salt has a lower solubility in water than the first lead salt, e.g. by at least 100 g/L, preferably by at least 200 g/L, and more preferably by at least 400 g/L. The second lead salt preferably has a solubility in water of up to 10 g/L, preferably up to 1 g/L, and more preferably up to 0.1 g/L.

As with the first acid, the second acid is preferably a Brønsted-Lowry acid, i.e. the second acid is a proton donor. The second acid may be an organic acid or an inorganic acid, however preferred second acids are organic acids. Particularly preferred is citric acid which forms a lead citrate precipitate. Since lead citrate has very low solubility under aqueous conditions, minimal citrate salt is ‘lost’ by remaining in solution.

The lead citrate precipitate will typically be present in the form of the compound having the formula Pb₃(C₆H₅O₇)₂. Some of the lead citrate may also be present in its less stable form of Pb(C₆H₈O₇) for instance if an excess of citric acid is present, though the lead citrate precipitate will typically consist of Pb₃(C₆H₅O₇)₂. Advantageously, tri-lead citrate requires a lower amount of citric acid to form than mono-lead citrate. The lead citrate precipitate may be in a hydrated form, typically Pb₃(C₆H₅O₇)₂ xH₂O, where x can be 1 to 3.

The second acid is preferably added to the solution of the first lead salt in an up to stoichiometric amount for the formation of the second lead salt from the lead ions in the solution of the first lead salt. By using a stoichiometric, or slightly under stoichiometric, amount of the second acid complete conversion of the second acid into the second lead salt is ensured.

The second acid may be added to the solution of the first lead salt in up to 100%, preferably up to 98%, and more preferably up to 95% of the stoichiometric amount required for the formation of the second lead salt. The second acid may be added to the solution of the first lead salt in at least 60%, preferably at least 75%, and more preferably at least 80% of the stoichiometric amount required for the formation of the second lead salt. Thus, the second acid may be added to the solution of the first lead salt in from 60 to 100%, preferably from 75 to 98%, and more preferably from 80 to 95% of the stoichiometric amount required for the formation of the second lead salt.

The amount of lead ions that are present in the solution of the first lead salt may be measured using known techniques. The amount of lead ions may be measured directly, e.g. using lead ion sensors, or indirectly. The amount of second acid required may then be calculated based on the measured amount of lead ions.

It will be appreciated that a stoichiometric amount of citric acid for conversion of the lead ions in the solution of the first lead salt to Pb₃(C₆H₅O₇)₂ is 0.67 moles per mole of lead ions.

This is demonstrated by the following equation in which lead acetate is converted into lead citrate:

3Pb(CH₃COO)₂+2C₆H₈O₇→Pb₃(C₆H₅O₇)₂+6CH₃COOH

Thus, citric acid may be added to the solution of the first lead salt in an amount of up to 0.67 moles, preferably up to 0.65 moles, and more preferably up to 0.63 moles per mole of lead ions in the solution. Citric acid may be added to the solution of the first lead salt in an amount of at least to 0.40 moles, preferably at least 0.50 moles, and more preferably at least 0.55 moles per mole of lead ions in the solution. Thus, citric acid may be added in an amount of from 0.40 to 0.67 moles, preferably from 0.50 to 0.65 moles, and more preferably from 0.55 to 0.63 moles per mole of lead ions in the solution of the first lead salt.

The second acid may be added to the solution of the first lead salt in the form of a powder or as an aqueous solution.

The precipitation of the second lead salt may take place at a temperature of at least −10° C., preferably at least 0° C., and more preferably at least 5° C. The precipitation of the second lead salt may take place at a temperature of up to 80° C., preferably up to 40° C., and more preferably up to 30° C. Thus, the precipitation of the second lead salt may take place at a temperature of from −10 to 80° C., preferably from 0 to 40° C., and more preferably from 5 to 30° C.

The second lead salt will typically be precipitated from the solution of the first lead salt at ambient pressure, i.e. without the application or removal of pressure.

Precipitation of the second lead salt may take place for a period of from 2 to 120 minutes, preferably from 5 to 60 minutes, and more preferably from 10 to 45 minutes.

The precipitate of the second lead salt is preferably separated from the lead-depleted solution before conversion into leady oxide. This enables water-soluble impurities which are present in the lead-containing waste to be removed as part of the lead-depleted solution.

Suitable methods for separating the precipitate of the second lead salt from the lead-depleted solution include filtration, though a variety of other methods may be used such as a settling tank or centrifugation. Smaller mesh sizes are typically preferred to ensure that all second lead salt precipitate is caught. However, in some embodiments, the second lead salt precipitate may be of a size that means that larger mesh sizes may be suitable.

The separated second lead salt may be washed, e.g. using water. This removes any water soluble impurities from the precipitate.

The second lead salt may also be purified. Suitable methods for purification include recrystallisation. However, generally purification is not required to provide the second lead salt with high purity.

The lead-depleted solution contains the first acid that was used to dissolve the lead-containing waste in step (a). Although this acid forms the relatively soluble first lead salt in step (a), it is regenerated on conversion of the first lead salt to the second lead salt in step (b). In preferred embodiments, the lead-depleted solution is recycled and used as the aqueous solution of the first acid for dissolving lead-containing waste in step (a). By recycling the lead-depleted solution, the first acid is not consumed but can be used repeatedly. Thus, the first acid may be perceived as a catalyst rather than a reagent in the recycling process.

The lead-depleted solution may also comprise residual lead, preferably in the form of the dissolved first lead salt. This is particularly the case when the second acid is used in step (b) in less than a stoichiometric amount as compared to the lead ions in the solution of the first lead salt. Recycling residual lead as part of the lead-depleted solution ensures that lead is not lost during the third further processing method.

In a third step (c) of the third further processing method, the precipitate of the second lead salt is converted into leady oxide. Leady oxide comprises PbO and, typically, also some metallic lead.

Preferably, the precipitate of the second lead salt is converted into leady oxide by calcination. This involves introducing the second lead salt precipitate into a calcination furnace and heating it to a temperature at which the salt decomposes and/or combusts to give leady oxide. Advantageously, where the second lead salt is lead citrate, the citrate acts as a fuel and combusts during calcination, thereby reducing the amount of energy that is required.

Calcination may take place at a temperature of at least 250° C., preferably at least 300° C., and more preferably at least 325° C. Calcination may take place at a temperature of up to 1000° C., preferably up to 600° C., and more preferably up to 450° C. Thus, calcination may take place at a temperature of from 250 to 1000° C., preferably from 300 to 600° C., and more preferably from 325 to 450° C. These temperatures are particularly suited to the calcination of lead citrate precipitate. The temperatures typically provide leady oxide comprising a mixture of PbO and Pb, with lower temperatures generally used for the preparation of leady oxide which is free from Pb.

Calcination may take place in an atmosphere which comprises oxygen. It will be appreciated that higher amounts of oxygen will generally favour the formation of PbO, while a low-oxygen environment will generally favour the formation of metallic lead.

Calcination may take place at an oxygen partial pressure of at least 0.01 atm, preferably at least 0.05 atm, and more preferably at least 0.1 atm. Calcination may take place at an oxygen partial pressure of up to 5 atm, preferably up to 1 atm and more preferably up to 0.5 atm. Thus, calcination may take place at an oxygen partial pressure of from 0.01 to 5 atm, preferably from 0.05 to 1 atm, and more preferably from 0.1 to 0.5 atm. For instance, calcination may take place in air at atmospheric pressure, i.e. without the application or removal of pressure.

Calcination may take place for a time period of from 10 minutes to 6 hours, preferably from 20 minutes to 2 hours, and more preferably from 30 minutes to 1 hour.

An advantage of the third further processing method is that the method is suitable for preparing leady oxide at very high purities. Thus, the leady oxide preferably comprises PbO and Pb in a total amount of at least 99%, preferably at least 99.5%, and more preferably at least 99.9% by weight. Leady oxides having these purities are comparable to those obtained using a Barton pot or ball-mill process, in which a lead ingot is oxidised. Purity may be measured using known method, e.g. spectroscopic techniques such as ICP-AES (inductively coupled plasma atomic emission spectroscopy). ICP-AES may be carried out as detailed in the examples.

In some instances, metallic lead, Pb, rather than leady oxide may be the desired product, in which case a temperature in excess of 1000° C. is preferably used in step (c) of the third further processing method. A reducing agent may also be used, e.g. carbon monoxide or coke, in which case temperatures which are lower than 1000° C. can also be used (e.g. 400 to 600° C.). Preferably, the partial pressure of oxygen in the system will be limited, for instance up to 0.000167 atm. An inert gas such as nitrogen or a vacuum may be used to displace oxygen from the reaction environment.

In other instances, lead citrate may be the desired product, in which case the third further processing method will not comprise step (c).

### EXAMPLES

The present invention will now be illustrated by way of the following non-limiting examples.

In the examples, X-ray diffraction was carried out on a D8 advance Bruker diffractometer and the collected data analysed with the software Highscore. The following settings were used: Cu Kα radiation with Ni-0.012 filter; operating at 40 kV at 40 mA; range: 5 to 90° 2theta; step size: 0.03°; scan rate: 3.5° min⁻¹.

Thermogravimetric analysis and differential scanning calorimetry were carried out with STA 409 EP Netzsch equipment. The following settings were used: in static air (chamber approximately 0.15 L); sample size: 20 to 30 mg; Temperature range: 0 to 600° C.; and heating rate: 5° C./min.

Inductively coupled plasma atomic emission spectroscopy (ICP-AES) was carried out using a Perkin Elmer Optima 8000 ICP-OES. The following settings were used: gas: argon; plasma gas flow: 8 L/min; auxiliary gas flow: 0.2 L/min; nebuliser gas flow: 0.7 L/min; RF power: 1500 watts.

Solid samples (usually 0.10 g to 0.50 g of powder) to be analysed with ICP-AES were subjected to different treatments, adapted to the specific composition of each sample, to fully dissolve them in aqueous media. Each treatment involved a combination of 1, 2 or 3 different solutions in specific orders. The solutions used were 70 wt % nitric acid, 30 wt % hydrogen peroxide and 1M potassium hydroxide (each 99.9% purity). Each preparation was then completed to 100 ml with nitric acid of concentrations chosen so that the concentration in nitric acid of the final solution amounted to 2 wt %.

Standard solutions were initially bought from Sigma, but subsequently standard solutions were prepared using ultra-pure elements from Sigma, deionised water and pure nitric acid to take into account matrix effects.

### Example 1: Desulfurising Waste Battery Paste at Different pH Levels

Waste lead-acid battery paste was obtained from spent traction sealed lead-acid batteries. The paste contained PbSO₄ in an amount of from approximately 65 to 70% by weight.

Desulfurisation

Samples of spent lead-acid battery paste (30.00 g) were added to aqueous sodium hydroxide (different strengths) to form aqueous slurries having a solids content of approximately 33% by weight. pH levels were maintained during the experiments, and the experiments terminated once the pH was stable without the addition of further sodium hydroxide.

Separation

The desulfurised lead-containing waste was separated from the aqueous solution by filtration and analysed to determine their sulfate concentration.

Results

The results of the experiments are shown in the following table:

| | Final | | Hydroxides |
|---|---|---|---|
| Experiment | pH | Desulfurisation | observed |
| A | 10.6 | 70% | Yes |
| B | 11.7 | 100% | Yes |
| C | 12.7 | 100% | Yes¹ |
| D | 13.2 | 100% | No |

¹in smaller amounts than in experiment B

### Example 2: Industrial Scale Desulfurisation

Desulfurisation was carried out on an industrial scale at a lead-containing waste processing facility. Very high levels of desulfurisation were obtained.

Specifically, a slurry of lead-containing waste (obtained from spent batteries) was passed to a closed circuit ball mill. The classifier on the ball mill was set to recycle particles that did not pass through a mesh having openings with a diameter of 75 μm to the ball mill for further grinding. Sodium hydroxide was added to maintain a pH level, measured in the classifier bath, of about 13.5.

The desulfurised waste was conditioned by the addition of water, before being passed through a filter press at a pressure between 5 and 10 bar. The remaining solid was washed with fresh water until the conductivity of the used wash water was no more than 1000 μS/cm greater than before the wash.

The desulfurised lead-containing waste contained less than 1% by weight of lead sulfate, and negligible levels of lead hydroxides.

### Example 3: Further Processing of Desulfurised Waste Battery Paste (Third Method)

Dissolution

Desulfurised lead-acid battery paste (10.00 g) was dissolved in a solution of glacial acetic acid (5.2 ml) in water (100 ml), followed by the addition of H₂O₂ (2.0 ml, 30 wt %). The dissolution of the majority of solids could be directly observed within tens of seconds, producing a clear and colourless solution with a minute proportion of insoluble material suspended in the liquid phase. The mixture was stirred at a rate of 500 rpm, at room temperature, for a period of 5 minutes.

The clear and colourless solution was then filtered. The filtride (3.4 wt % of the paste) was analysed and showed to be mainly BaSO₄, carbon and fibres.

Precipitation of Lead Citrate

Solid crystals of citric acid (5.17 g) were added to the filtrate from the dissolution step. The precipitation of white lead citrate began instantaneously but the solution was left to react for 1 hour at 80° C. under stirring at 400 rpm. The solution was then filtered and the filtride (lead citrate) recovered, dried and weighed. The mass obtained was 13.12 g, which is very close to the expected figure of 13.32 g. X-ray diffraction was used to confirm that the powder obtained was exclusively Pb₃(C₆H₅O₇)₂; thermogravimetric analysis on both pure Pb₃(C₆H₅O₇)₂ and the synthesised powder showed a perfect match. ICP-AES analysis on the powder showed complete absence of S, Ba, Sn, Al, Fe, Zn and Sb (0%); a Cu content in the order of magnitude of 10 ppm; and Na content in the order of magnitude of 500 ppm.

With a more stringent washing protocol, the Na content was reduced to figures below 100 ppm, thereby demonstrating that Na content in the above examples is a function of the quality of water and efficiency of washing.

Calcination of Lead Citrate

Lead citrate (10.00 g) was heated in a muffle furnace at 350° C. for 1 hour in air then left to cool down to room temperature. The resultant orange/yellow/green powder (lead monoxide) was then recovered and analysed. The expected mass for a total combustion of Pb₃(C₆H₅O₇)₂ to PbO was 6.70 g. The actual mass of material obtained by the process was 6.18 g; this is because some of the PbO was reduced to lead metal (Pb) during the calcination-combustion process. The presence of Pb was confirmed by differential scanning calorimetry.

The powder was analysed with XRD to confirm that the phase obtained was PbO. ICP-AES was used to confirm the high purity of the material, which was equivalent to the purity levels seen in the case of the lead citrate above.

### Example 4: Further Processing of a Desulfurised Spent Battery Negative Grid (Third Method)

Dissolution

A desulfurised spent battery negative grid (50.00 g) was dissolved in aqueous acetic acid solution (400 ml, 8 wt %) and stirred at 400 rpm for 10 min. H₂O₂ was not added as the grid was a negative plate and did not contain any PbO₂. The volume of solids in suspension visibly decreased due to dissolution.

The solution was then filtrated and the filtride was analysed and found to be mainly BaSO₄, carbon, fibres and fragments of metal Pb from the grid amounting to 7 wt % of the total mass of paste.

Part of the solution was evaporated to crystallise what was expected to be lead acetate. XRD pattern for the crystals showed a perfect match for pure lead acetate trihydrate and the decomposition of the crystals with thermogravimetry showed similar decomposition patterns confirming that the solution produced is indeed a solution of lead acetate.

Precipitation of Lead Citrate

A solution of citric acid (10 ml, 50 wt %) was added to the filtrate (200 ml) and stirred for 10 min at room temperature. Precipitation of a white solid was immediately observed. The precipitate was then filtered out, dried and weighed. The mass obtained was 12.76 g which was close to the expected 12.88 g corresponding to the maximum amount of lead citrate that could be formed with the amount of citric acid used.

XRD and thermogravimetric analysis showed a perfect match for Pb₃(C₆H₅O₇)₂.

Combustion of Lead Citrate

The precipitate was combusted in a muffle furnace under air at 400° C. for 1 hour and analysed under XRD. Colour turned from pure white to bright orange which indicated the formation of PbO and was confirmed with XRD analysis. The only other phase that could be detected was metal Pb.

### Example 5: Further Processing of Electric Arc Furnace Dusts (Third Method)

Samples of steel industry dust were obtained. The samples had previously been subjected to a conventional zinc recovery treatment and contained approximately 60 to 70% by weight of PbSO₄. The samples were subjected to desulfurisation using NaOH, followed by conversion into lead citrate and calcination.

Initial recycling experiments on the samples showed that desulfurisation and conversion into lead citrate proceeded slowly. Further analysis of the samples revealed the presence of C and SiO₂ in an amount of approximately 20 to 30% by weight which was believed to be coating the particles in the sample.

Samples of the as-received material were pre-heated to 500 and 600° C. to determine the optimum pre-treatment temperature required to eliminate carbon. The samples were heated at a rate of 5° C. per minute and the temperature held at either 500 or 600° C. for a period of 1 hour. Though the amount of carbon decreased in both samples, the sample treated at 600° C. showed a significantly greater decrease of carbon than the sample treated at 500° C.

The pre-treated samples were desulfurised using NaOH, converted into lead citrate and then calcined in air at 450° C. to give leady oxide. The leady oxide products contained PbO and metallic Pb, with the highest purity product obtained from the sample that was pre-treated at 600° C.

1. A method for desulfurising lead-containing waste, the lead containing waste comprising PbSO₄, said method comprising:
(a) treating an aqueous slurry of the lead-containing waste with a hydroxide base thereby forming desulfurised lead-containing waste in which PbSO₄ has been converted to PbO and an aqueous solution comprising sulfate anions; and
(b) separating the desulfurised lead-containing waste from the aqueous solution comprising sulfate anions,
wherein a pH in the range of from 11 to 15 is maintained during step (a).

2. The method of claim 1, wherein the lead-containing waste comprises Pb, PbO, PbO₂, or a combination thereof.

3. The method of claim 1, wherein the lead-containing waste is derived from lead-acid battery paste or from electric arc furnace dusts.

4. The method of claim 1, wherein the lead-containing waste used in step (a) is in a particulate form where at least 100% by weight of the granules pass through a mesh having openings with a diameter of 1 cm.

5. The method of claim 1, wherein a pH in the range of from 11.5 to 14.5 is maintained in step (a).

6. The method of claim 1, wherein the pH is maintained during step (a) by further addition of the hydroxide base to the aqueous slurry.

7. The method of claim 1, wherein the base is a metal hydroxide base.

8. The method of claim 1, wherein the hydroxide base is consumed in step (a) in an amount of from 1.9 to 2.1 moles per mole of lead sulfate in the lead-containing waste.

9. The method of claim 1, wherein the aqueous slurry in step (a) has a solids content of from 30 to 80% by weight.

10. The method of claim 1, wherein step (a) is carried out at a temperature of from 0 to 70° C.

11. The method of claim 1, wherein the lead-containing waste is comminuted during step (a).

12. The method of claim 11, wherein step (a) is carried out in a mill.

13. The method of claim 12, wherein the mill is operated at a speed of from 5 to 60 rpm.

14. The method of claim 12, wherein the mill is operated:
in a continuous mode; and/or
as a closed circuit mill.

15. The method of claim 11, wherein the desulfurised lead-containing waste that is produced in step (a) is in a particulate form, where at least 80% by weight of the particles pass through a mesh having openings with a diameter of 150 μm or less.

16. The method of claim 1, wherein a conditioning step is carried out between steps (a) and (b), the conditioning step comprising:
leaving the desulfurised lead-containing waste and the aqueous solution comprising sulfate ions that are formed in step (a) in a tank for a period of time; and/or then
adding water to the desulfurised lead-containing waste and the aqueous solution comprising sulfate ions that is formed in step (a).

17. The method of claim 1, wherein the desulfurised lead-containing waste is separated from the aqueous solution comprising sulfate anions using filtration.

18. The method of claim 1, wherein step (b) comprises washing the desulfurised lead-containing waste with water and monitoring the sulfate content of the used wash water to determine when a target level of sulfate has been achieved.

19. The method of claim 18, wherein monitoring comprises measuring the conductivity of the used wash water.

20. The method of claim 1, wherein:
at least 95% of the sulfur is removed from the lead-containing waste; and/or
at least 95% of the lead that was present in the lead-containing waste used in step (a) is retained.

21. The method of claim 1, wherein the desulfurised lead-containing waste which is obtained at the end of step (b) comprises:
PbSO₄ in an amount of less than 1% by weight;
lead hydroxide forms in an amount of less than 1% by weight;
PbCO₃ in an amount of less than 2% by weight; and/or
PbO in an amount of at least 40% by weight.

22. A desulfurised lead-containing waste which is obtainable using a method as defined in claim 1.

23. A desulfurised lead-containing waste, which comprises:
PbO in an amount of at least 40%;
PbO₂ in an amount of at least 10%;
Pb in an amount of at least 1%; and
lead hydroxide forms in an amount of less than 5%,
by weight.

24. A method of recycling lead-containing waste, said method comprising processing a desulfurised lead-containing waste into a lead-containing material, wherein the desulfurised lead-containing waste is as defined in claim 22.

25. The method of claim 24, wherein the desulfurised lead-containing waste is further processed:
in furnace into a lead ingot;
or by:
(a) treating waste with aqueous citric acid solution so as to generate lead citrate;
(b) isolating lead citrate from the aqueous solution; and
(c) converting the isolated lead citrate to Pb and/or PbO;
or by:
(a) dissolving the lead-containing waste in an aqueous solution of a first acid to form a solution of a first lead salt;
(b) adding a second acid to the solution of the first lead salt to form a lead-depleted solution and a precipitate of a second lead salt; and
(c) converting the precipitate of the second lead salt into leady oxide,
wherein the first lead salt has a higher solubility in water than the second lead salt.
